(19) United States
(12) Patent Application Publication
(10) Pub. No.: US 2023/0103224 A1
(43) Pub. Date: Mar. 30, 2023

(54) SECURE ARCHITECTURE FOR BIOMETRIC AUTHENTICATION

(71) Applicant: Kansas State University Research Foundation, Manhattan, KS (US)

(72) Inventors: George T. Amariucai, Manhattan, KS (US); Pascal Hitzler, Manhattan, KS (US); Abhishek Jana, Manhattan, KS (US); Monireh Ebrahimi, Manhattan, KS (US); Md Kamruzzaman Sarker, Manhattan, KS (US)

(21) Appl. No.: 17/911,221

(22) PCT Filed: Mar. 11, 2021
(86) PCT No.: PCT/US2021/021834

§ 371 Date: Sep. 13, 2022

Related U.S. Application Data
(60) Provisional application No. 62/990,716, filed on Mar. 17, 2020.

(51) Int. Cl. H04L 9/32

(52) U.S. Cl. CPC H04L 9/3231

(57) ABSTRACT

Computer-implemented methods, systems and computer-readable media for building and using an artificial intelligence model for secure biometric authentication. Utilizing difference vectors, the model securely relates output vectors generated from noisy biometric data of a plurality of enrolled users to pre-defined fixed points in a vector space.

### CROSS-REFERENCE TO RELATED APPLICATIONS

The present application claims the benefit of and priority from identically-titled U.S. Provisional Patent Application Ser. No. 62/990,716, filed Mar. 17, 2020, the entire disclosure of which is hereby incorporated by reference herein.

### FIELD OF THE INVENTION

The present disclosure generally relates to computer-implemented methods, systems comprising computer-readable media, and electronic devices for authenticating an individual. More particularly, the present disclosure generally relates to electronic devices for authenticating an individual exhibiting one or more biometric factor(s).

### BACKGROUND

Modern approaches to biometric authentication, based on sophisticated machine learning techniques, cannot avoid storing either trained-classifier details or explicit user biometric data exposing users' credentials to falsification.

In the case of fingerprint-based authentication, similarity-score algorithms based on artificial neural networks (ANNs) usually perform slightly better than fuzzy extractors, and this has led to a preference for the former. Similarly, ANNs are known to outperform even the best of support-vector machines (SVMs) (at least in situations in which training data is abundant), and this is attributed to their ability to learn highly-irregular classification functions.

However, using similarity-score algorithms involves the storing of fingerprint databases, which are vulnerable to leakage. Unfortunately, both SVMs and ANNs (as well as the other frequently-used classifiers, like k-nearest neighbors (KNN), decision trees and random forests, etc.) rely on learned structures that have to be stored in non-volatile memory, similarly to a password file. A malicious user, with access to this information, could use the learned structure (for example, by back-tracking through an ANN, or by simply choosing a vector in the proper decision region, for an SVM) to produce synthetic inputs guaranteed to pass the authentication test. Similar problems are encountered when using similarity-score algorithms in connection with authentication based on other biometric factors.

Embodiments of the present invention provide an improved system and method for individual biometric authentication. This background discussion is intended to provide information related to the present invention which is not necessarily prior art.

### BRIEF SUMMARY

Embodiments of the present technology relate to improved computer-implemented methods, systems comprising computer-readable media, and electronic devices for authenticating an individual exhibiting one or more biometric factors.

In a first aspect, a computer-implemented method for building an artificial intelligence model to perform secure biometric authentication may be provided. The computer-implemented method may include: inputting representations of noisy biometric data into an artificial intelligence classifier to generate output vectors in a vector space, where the noisy biometric data are derived from sensor readings of a biometric factor for a plurality of enrolled users; partitioning the vector space into a plurality of regions, where each of the regions includes a pre-defined partitioned fixed point associated with one of the enrolled users; calculating a difference vector for each of the enrolled users based on a difference between: (i) a representative location of those of the output vectors that correspond to the enrolled user, and (ii) the pre-defined partitioned fixed point corresponding to the enrolled user; and generating and storing in one or more databases a record for each of the enrolled users that includes the corresponding difference vector and an authentication string comprising a cryptographically converted version of the corresponding representative location or the corresponding pre-defined partitioned fixed point. The method may include additional, less, or alternate actions, including those discussed elsewhere herein.

In another aspect, a system for building an artificial intelligence model to perform secure biometric authentication may be provided. The secure authentication system may include one or more processors individually or collectively programmed to perform the following steps: inputting representations of noisy biometric data into an artificial intelligence classifier to generate output vectors in a vector space, where the noisy biometric data are derived from sensor readings of a biometric factor for a plurality of enrolled users; partitioning the vector space into a plurality of regions, where each of the regions includes a pre-defined partitioned fixed point associated with one of the enrolled users; calculating a difference vector for each of the enrolled users based on a difference between: (i) a representative location of those of the output vectors that correspond to the enrolled user, and (ii) the pre-defined partitioned fixed point corresponding to the enrolled user; and generating and storing in one or more databases a record for each of the enrolled users that includes the corresponding difference vector and an authentication string comprising a cryptographically converted version of the corresponding representative location or the corresponding pre-defined partitioned fixed point. The system may include additional, less, or alternate functionality, including that discussed elsewhere herein.

In still another aspect, a system comprising computer-readable media having computer-executable instructions stored thereon for building an artificial intelligence model to perform secure biometric authentication may be provided. The computer-readable instructions may instruct at least one processor to perform the following steps: inputting representations of noisy biometric data into an artificial intelligence classifier to generate output vectors in a vector space, where the noisy biometric data are derived from sensor readings of a biometric factor for a plurality of enrolled users; partitioning the vector space into a plurality of regions, where each of the regions includes a pre-defined partitioned fixed point associated with one of the enrolled users; calculating a difference vector for each of the enrolled users based on a difference between: (i) a representative location of those of the output vectors that correspond to the enrolled user, and (ii) the pre-defined partitioned fixed point corresponding to the enrolled user; and generating and storing in one or more databases a record for each of the enrolled users that includes the corresponding difference vector and an authentication string comprising a cryptographically converted version of the corresponding representative location or the corresponding pre-defined partitioned fixed point. The computer-readable instructions may instruct the processor(s) to perform additional, fewer, or alternative actions, including those discussed elsewhere herein.

In yet still another aspect, a computer-implemented method for authenticating an individual exhibiting one or more biometric factors may be provided. The computer-implemented method may include: receiving authentication biometric sensor data from an authentication sensor reading of a biometric factor of a putative user; inputting the authentication biometric sensor data to an artificial intelligence classifier to generate an authentication output vector; retrieving an authentication string and a difference vector, where each of the authentication string and the difference vector are associated with an enrolled user in one or more databases; identifying a pre-defined fixed point in a vector space at least in part by subtracting the difference vector from the output vector; and matching the authentication string to the identified fixed point to authenticate that the putative user matches the enrolled user. The method may include additional, less, or alternate actions, including those discussed elsewhere herein.

In yet still another aspect, a system for authenticating an individual exhibiting one or more biometric factors may be provided. The secure authentication system may include one or more processors individually or collectively programmed to perform the following steps: receiving authentication biometric sensor data from an authentication sensor reading of a biometric factor of a putative user; inputting the authentication biometric sensor data to an artificial intelligence classifier to generate an authentication output vector; retrieving an authentication string and a difference vector, where each of the authentication string and the difference vector are associated with an enrolled user in one or more databases; identifying a pre-defined fixed point in a vector space at least in part by subtracting the difference vector from the output vector; and matching the authentication string to the identified fixed point to authenticate that the putative user matches the enrolled user. The system may include additional, less, or alternate functionality, including that discussed elsewhere herein.

In yet still another aspect, a system comprising computer-readable media having computer-executable instructions stored thereon for authenticating an individual exhibiting one or more biometric factors may be provided. The computer-readable instructions may instruct at least one processor to perform the following steps: receiving authentication biometric sensor data from an authentication sensor reading of a biometric factor of a putative user; inputting the authentication biometric sensor data to an artificial intelligence classifier to generate an authentication output vector; retrieving an authentication string and a difference vector, where each of the authentication string and the difference vector are associated with an enrolled user in one or more databases; identifying a pre-defined fixed point in a vector space at least in part by subtracting the difference vector from the output vector; and matching the authentication string to the identified fixed point to authenticate that the putative user matches the enrolled user. The computer-readable instructions may instruct the processor(s) to perform additional, fewer, or alternative actions, including those discussed elsewhere herein.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals. The present embodiments are not limited to the precise arrangements and instrumentalities shown in the Figures.

FIG. 1 illustrates in schematic form various components of an exemplary system for enrolling and authenticating an individual exhibiting biometric factor(s), according to embodiments of the present invention;

FIGS. 2 and 3 respectively illustrate in block schematic form various components of exemplary authentication and sensor devices that may be used with the system of FIG. 1;

FIG. 4 is a flowchart of various logical components of an exemplary artificial intelligence model for enrolling and authenticating individuals exhibiting biometric factors, accompanied by two-dimensional representations of exemplary biometric data progressing through various stages of the model, in accordance with embodiments of the present invention;

FIG. 5 illustrates, in two dimensions, decoding exemplary biometric data in a secure sketch in support of authentication operations, in accordance with embodiments of the present invention;

FIG. 6A illustrates at least a portion of the steps of an exemplary computer-implemented method for enrolling a plurality of enrolled users for authentication in accordance with embodiments of the present invention; and

FIG. 6B illustrates at least a portion of the steps of an exemplary computer-implemented method for authenticating a putative user in accordance with embodiments of the present invention.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

As outlined above, modern systems for authenticating an individual with high accuracy based on biometric factors are susceptible to modeling and/or hacking attacks, at least because of the way(s) in which the relevant artificial intelligence models are constructed and stored for use in the authentication process. Embodiments of the present invention provide stronger resilience against security attacks, particularly where the adversary may breach an authentication device that stores the model(s) and/or structural or learned information relied on by the model(s).

In embodiments of the present invention described in more detail below, a novel approach to constructing and using artificial intelligence models for authentication of individuals exhibiting biometric factors is proposed. Embodiments of the present invention include a blended model utilizing a classifier producing output vectors in a vector space, partitioned fixed points (e.g., as defined in a secure sketch) in the vector space, and storage of difference vectors relating the output vectors and partitioned fixed points. Where appropriate, the blended model employs novel expanders to achieve interoperation of the classifier and fixed-point components. Embodiments of the present invention provide an optimized combination of accurate and secure authentication technologies.

Specific embodiments of the technology will now be described in connection with the attached drawing figures. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

### Exemplary System

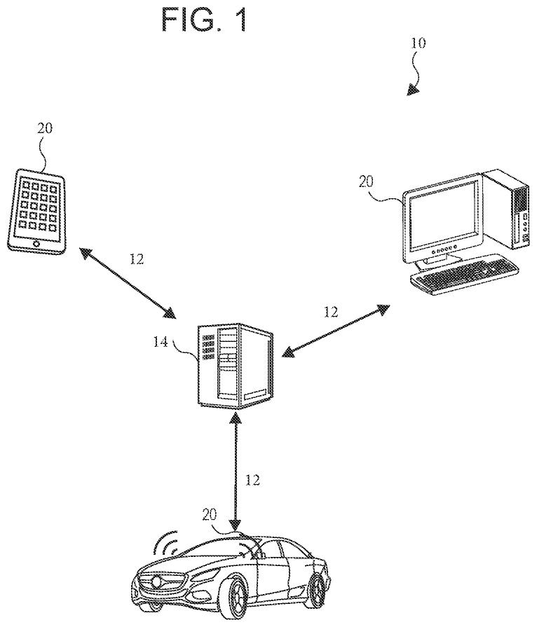

FIG. 1 depicts an exemplary environment in which embodiments of a system 10 may be utilized for authenticating one or more enrolled users exhibiting one or more biometric factor(s). One of ordinary skill will appreciate that, while certain biometric factors may be more conducive to accurate and speedy authentication, any of a variety of biometric factors (or any combination thereof) may be utilized in embodiments of the present invention such as, for instance: fingerprint patterns; deoxyribonucleic acid patterns; ocular iris patterns; ocular retina patterns; facial structure or geometric patterns; finger or hand geometric patterns; voice print patterns; typing patterns; ear structure or geometric patterns; gait patterns; infrared body heat patterns; vein or cardiovascular patterns; odor recognition; speech patterns; and written signature patterns.

The environment may include communication links 12 for enabling electronic communications between components of the system 10. The system 10 may include an authentication device 14 and one or more sensor devices 20. The authentication device 14 may manage enrollment of the plurality of enrolled users for authentication processes, as described in more detail below. Further, the authentication device 14 may also manage real-time authentication of the enrolled users following enrollment, also as described in more detail below. One of ordinary skill will appreciate, however, that enrollment and subsequent authentication functions may be performed by different physical computing devices, though they are described herein as being performed by the same authentication device 14 for ease of reference. Moreover, one of ordinary skill will also appreciate that the sensor devices 20 may be integrated with the authentication device 14 (e.g., where the authentication device 14 includes a sensor element 22) without departing from the spirit of the present invention.

The system 10 may be utilized across a variety of industries for secure biometric authentication, including complex infrastructure and cyber-physical systems spanning different domains such as medical, defense, transportation and agriculture. In one or more embodiments, e.g., Internet of Things (IoT) embodiments—the sensor devices 20 may continuously or periodically record and transmit biometric data for authentication according to the protocols set forth herein.

In a preferred embodiment, the sensor devices 20 may be constructed according to higher-level computational architectures and hardware of devices such as smartphones, laptop computers or the like. For example, smart phones 20 may include a variety of sensors 22, including image, infrared, global positioning system (GPS), accelerometer, gyroscope, magnetometer, ambient light and/or microphone sensor(s) for recording biometric data captured about the enrolled users' bodies, such as data regarding fingerprint patterns, ocular iris patterns, ocular retina patterns, facial structure or geometric patterns, finger or hand geometric patterns, voice print patterns, typing patterns, ear structure or geometric patterns, gait patterns, infrared body heat patterns, vein or cardiovascular patterns, speech patterns and/or written signature patterns. For another example, laptop computers 20 may include peripheral devices such as keyboards having sensors 22 for recording keystrokes and/or typing patterns and/or image sensors 22 for capturing optical and/or infrared biometric data corresponding to factors listed above in connection with smart phone 20. For still another example, vehicles 20 may include a variety of sensors (e.g., those listed in connection with the smart phones 20 above) for capturing biometric data relating to driving patterns along with the factors listed above in connection with smart phone 20.

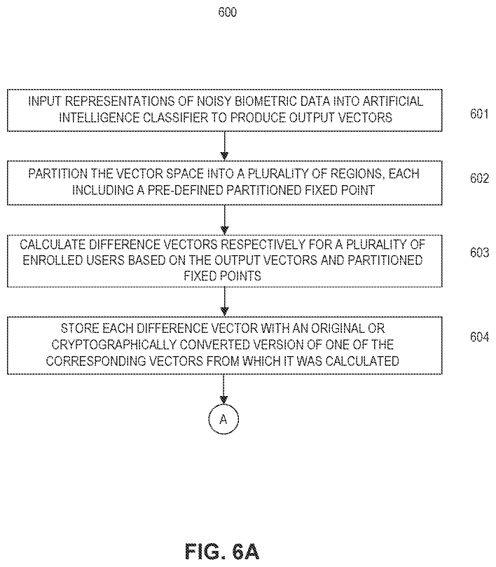

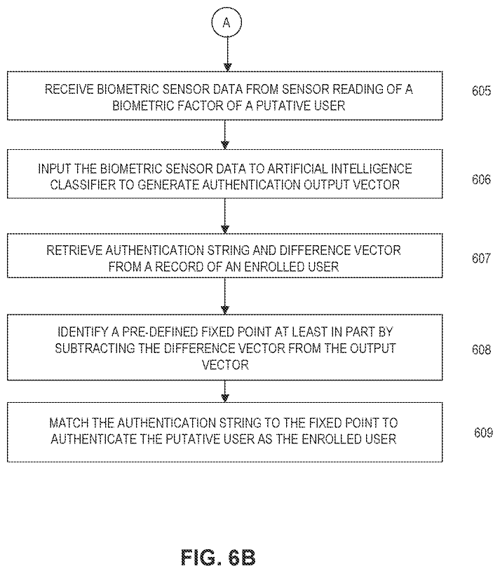

It is foreseen that, in one or more embodiments, the sensor devices 20 may not include processing, memory and/or communications elements and/or that the sensor(s) 22 may be integrated with the authentication device 14, without departing from the spirit of the present invention. Each sensor device 20 may optionally execute a sensor program, as described in more detail below, for managing at least some of the steps of embodiments of the present invention exemplified in FIGS. 6A-B hereof. Likewise, the authentication device 14 may execute an authentication device program 26 for managing at least some of the steps for enrollment and authentication set out in FIGS. 6A-B.

Broadly, the communication links 12 may allow communication between the sensor devices 20 and the authentication device 14. One or more of the communication links 12 may include or comprise local area networks, metro area networks, wide area networks, cloud networks, the Internet, cellular networks, plain old telephone service (POTS) networks, and the like, or combinations thereof. The communication links 12 may be wired, wireless, or combinations thereof and may include components such as modems, gateways, switches, routers, hubs, access points, repeaters, towers, and the like. For example, the sensor devices 20 may generally connect to the communication links 12 and/or to the authentication device 14 wirelessly, such as radio frequency (RF) communication using wireless standards such as cellular 2G, 3G, 4G, or 5G, Institute of Electrical and Electronics Engineers (IEEE) 802.11 standards such as WiFi, IEEE 802.16 standards such as WiMAX, Bluetooth®, or combinations thereof. Also or alternatively, the sensor devices 20 may generally connect to the communication links 12 and/or to the authentication device 14 via Bluetooth® wireless communication protocol in general, or the Bluetooth® low energy (BLE) protocol. In one or more embodiments, communication links 12 may be secured in connection with communications exchanged between sensor devices 20 and the authentication device 14 during enrollment procedures and/or authentication procedures, for example with respect to the exchange of biometric data. “Secured” may generally refer to implementation of one or more of encryption protocols, additional authentication protocols, data expiration or the like and/or to utilizing air gaps, air walls, air gapping, disconnected networks and/or the like to enhance security of electronic communications.

The authentication device 14 generally retains electronic data and may respond to requests to retrieve data as well as to store data. The authentication device 14 may be embodied by application servers, communication servers, database servers, file servers, gaming servers, mail servers, print servers, web servers, or the like, or combinations thereof. Furthermore, the authentication device 14 may include a plurality of servers, virtual servers, or combinations thereof. The authentication device 14 may also or alternatively be embodied by a smart watch, a smart phone, a personal digital assistant (PDA), a tablet, a palmtop or laptop computer, a notebook, a netbook, smart glasses, wearable and non-wearable electronics (e.g., any IoT device), or other mobile device, without departing from the spirit of the present invention.

The authentication device 14 may be configured to include or execute software such as file storage applications, database applications, email or messaging applications, web server applications, or the like, in addition to and/or in conjunction with the authentication device program 26. The authentication device 14 may apply business methods or algorithms, may utilize and/or manage lookup tables or databases, receive user input via one or more peripheral devices or associated systems, or perform other tasks. The authentication device 14 may perform tasks in order to enroll and/or authenticate enrolled users on the basis of biometric data collected by sensor devices 20, and/or to perform other tasks outlined throughout this disclosure.

The authentication device 14 may further include a communication element 30, a processing element 34, and a memory element 38.

One or more of the sensor devices 20 may be embodied by a medical device, a data cloud and/or data center computer, a smart watch, a smart phone, a personal digital assistant (PDA), a tablet, a palmtop or laptop computer, a notebook, a netbook, smart glasses, wearable and non-wearable electronics (e.g., any IoT device), or other mobile device. Each sensor device 20 may include a memory element 48, a processing element 52, and a communications element 56, as seen in FIG. 3. The memory element 48 may store the sensor program, and the processing element 52 may execute the sensor program. The sensor devices 20 may also generally include electrical power sources housed in small boxes or packages for powering the components thereof outlined herein. Also or alternatively, as noted above, the sensor devices 20 may be integrated with the authentication device 14 in embodiments of the present invention.

The communication elements 30, 56 may allow communication between one another and/or with external systems or devices. The communication elements 30, 56 may include signal or data transmitting and receiving circuits, such as antennas, amplifiers, filters, mixers, oscillators, digital signal processors (DSPs), and the like. The communication elements 30, 56 may establish communication wirelessly by utilizing RF signals and/or data that comply with communication standards such as cellular 2G, 3G, 4G, or 5G, IEEE 802.11 standard such as WiFi, IEEE 802.16 standard such as WiMAX, Bluetooth®, or combinations thereof. Alternatively, or in addition, the communication elements 30, 56 may establish communication through connectors or couplers that receive metal conductor wires or cables which are compatible with networking technologies such as ethernet. In certain embodiments, the communication elements 30, 56 may also couple with optical fiber cables. The communication elements 30, 56 may be in communication with or electronically coupled to memory elements 38, 48 and/or processing elements 34, 52.

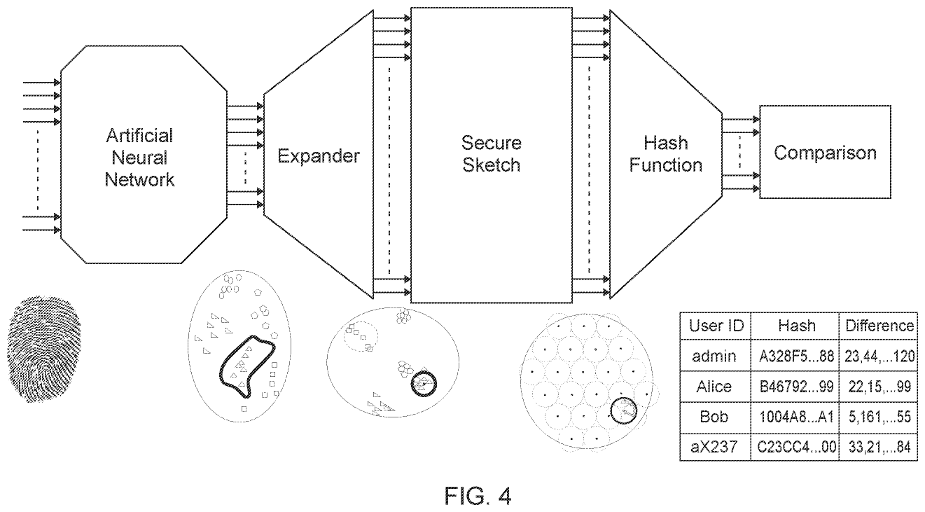

The memory elements 38, 48 may include data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, USB ports, or the like, or combinations thereof. The memory elements 38, 48 may include, or may constitute, a “computer-readable medium.” The memory elements 38, 48 may store the instructions, code, code segments, software, firmware, programs, applications, apps, services, daemons, or the like that are respectively executed by the processing elements 34, 52. The memory elements 38, 48 may comprise non-volatile memory areas for storing programs 26, 22. The memory elements 38, 48 may also store settings, data, documents, sound files, photographs, movies, images, databases, and the like. For example, the memory element 38 may store and maintain a database, and the memory element 48 may comprise non-volatile memory configured to store one or more values discussed in more detail below. (See also FIG. 4)

The processing elements 34, 52 may include processors. The processing elements 34, 52 may include microprocessors, microcontrollers, DSPs, field-programmable gate arrays (FPGAs), analog and/or digital application-specific integrated circuits (ASICs), or the like. The processing elements 34, 52 may include digital processing unit(s). The processing elements 34, 52 may include combinations of any of the foregoing. The processing elements 34, 52 may generally execute, process, or run instructions, code, code segments, software, firmware, programs, applications, apps, processes, services, daemons, or the like. The processing elements 34, 52 may also include hardware components, such as finite-state machines, comparators, sequential and combinational logic, and other electronic circuits that may perform the functions necessary for the operation of embodiments of the current inventive concept. The processing elements 34, 52 may be in communication with the other electronic components through serial or parallel links that include address busses, data busses, control lines, and the like.

Again, all or some of the illustrated functional components of the sensor device 20 may be implemented within the authentication device 14. However, one of ordinary skill will appreciate that multiple devices may implement the illustrated functional aspects, and that such functional aspects may be distributed differently among such authentication and sensor device(s), without departing from the spirit of the present invention.

The authentication device 14 may embody and/or access a database (e.g., embodied in non-volatile memory spaces (NVM)) for storing records, each record comprising an entry containing data elements discussed in more detail below. As will be discussed in more detail below, the data elements may be stored in various forms to enhance security benefits outlined above. Moreover, one of ordinary skill will appreciate that, while the database may be embodied in a common tabular format with columns and rows, any of various types of database structures may be implemented within the scope of the present invention. For instance, data structures for storing relationships between and/or indexing entries containing data elements of each group or record may be embodied within other relational and/or object-oriented databases without departing from the scope of the present invention.

Other logical components associated with the authentication device 14 may include code segments for artificial intelligence model supervised training and/or data hashing or encrypting, and/or authenticity determining functions described in more detail below. It should be noted again here that, in a preferred embodiment, all or some of these logical components or code segments may be subsumed by or embodied within the software program 26 of the authentication device 14. It should also be noted that embodiments of the present invention may omit one or more of such code segments (e.g., the hashing function) without departing from the spirit of the present invention.

Exemplary Methods for Enrolling and Authenticating Users Based on Biometric Data from Sensor Devices

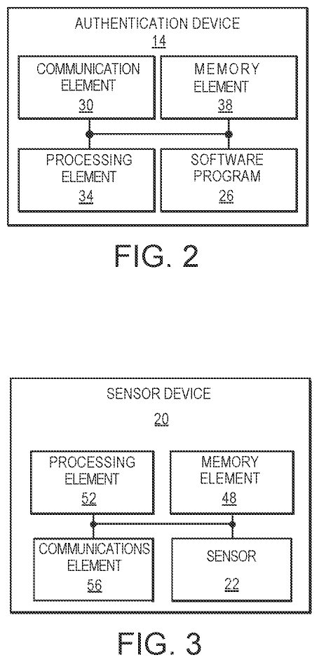

FIGS. 6A-B depict a listing of steps of exemplary computer-implemented methods 600 for enrolling and authenticating a plurality of enrolled users. Some steps may be performed concurrently as opposed to sequentially, and may in some cases be performed in a different order. In addition, some steps may be optional. The computer-implemented method(s) 600 are described below, for ease of reference, as being executed by exemplary devices and components introduced with the embodiments illustrated in FIGS. 1-4. For example, the steps of the computer-implemented method(s) 600 may be performed by the authentication device 14, and at least in part by the sensor devices 20, and/or communication links 12 through the utilization of processors, transceivers, hardware, software (such as the sensor program and software application 26 described herein), firmware, or combinations thereof. In one or more embodiments, the steps set out below for authentication of a single enrolled user are substantially the same as for other sensor devices and enrolled users. A person having ordinary skill will also appreciate that responsibility for all or some of such actions may be distributed differently among such devices or other computing devices without departing from the spirit of the present invention. In one or more embodiments, the steps described below are performed by the authentication device unless expressly linked to the sensor device.

One or more computer-readable medium(s) may also be provided. The computer-readable medium(s) may include one or more executable programs, such as a sensor device program and an authentication device program, stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Enrollment

The steps set out herein generally correspond to the flowchart illustrated in FIG. 6A.

Referring to step 601 of FIG. 6A, representations of noisy biometric data are input into an artificial intelligence classifier to produce or generate output vectors. In one or more embodiments, the noisy biometric data comprises input vectors derived from sensor readings of a biometric factor for a plurality of enrolled users.

As noted above, the biometric data may include images of individuals' faces, facial features, and/or hands or fingers, infrared pictures of aspects of individuals' bodies, records of computing activities (such as typing speed or patterns) sensed by peripheral devices of computers, GPS and/or other driving-related data reflecting driving patterns, or any other biometric data. “Noisy” biometric data is data about a biometric factor that includes additional meaningless information called “noise.” The “noise” may result from imperfections or inconsistencies in taking sensor readings, ambient environmental factors, changing body conditions or conformations, or other causes.

In one or more embodiments, biometric data regarding a biometric factor will be collected multiple times, through multiple sensor readings, for each of the enrolled users. For example, multiple fingerprint scans may be collected from each enrolled user, and each enrolled user may be asked to remove the selected finger and replace it on the fingerprint scanner sensor between each scan to approximate the impact of “noise” expected to be experienced during later authentication procedures. For another example, biometric data comprising records of computing activities may be collected across a plurality of user sessions of the same or similar type for each user, again in an attempt to approximate “noise” expected to be experienced during later authentication procedures. Groups or clusters of output vectors produced from repeated, independent sensor measurements with respect to an individual enrolled user reflect some or most of the “noise” typically present in biometric authentication data. However, one of ordinary skill will appreciate that a single reading and a single-member cluster associated with each enrolled user may be used without departing from the spirit of the present invention.

For each enrolled user, all or some of the biometric data from the one or more sensor readings is input as one or more input vectors into the artificial intelligence classifier to produce one or more corresponding output vectors. The artificial intelligence classifier may comprise any classifier for producing multi-dimensional output vectors for classification, such as an artificial neural network (e.g., a deep neural network), a support vector machine, or a K-nearest-neighbors algorithm.

Turning briefly to FIG. 4, an exemplary artificial intelligence model includes a classifier comprising an artificial neural network and an expander. The exemplary artificial neural network (e.g., a deep neural network) comprises a plurality of neural network layers that may be trained on input vectors (i.e., input vectors comprising representations of biometric data derived from sensor readings of the biometric factor) that are labeled (i.e., associated with corresponding ones of the plurality of enrolled users).

The artificial neural network of FIG. 4 may be referred to as an “original” neural network before the illustrated expander is appended to it. In one or more embodiments, the original neural network may be trained on labeled input vectors to improve—e.g., using customary backpropagation and loss function techniques—classification of the input vectors as corresponding to particular ones of the enrolled users. The output vectors associated with a given enrolled user will, following training, group or cluster together in a corresponding vector space. In one or more embodiments, the corresponding vector space and output vectors may be said to have N-dimensionality.

As illustrated in FIG. 4, the output vectors of the original neural network for one or more of the enrolled users may cluster in non-spherical or merely semi-spherical groupings within the N-dimensional vector space. Where the lack of sphericity is likely to reduce interoperability with secure sketch operations described in more detail below, an expander may be appended to a plurality of the layers of the original neural network to produce output vectors of enhanced spherical clustering. For example, in one or more embodiments, at least one (and possibly several) of the final layers of the trained original neural network may be peeled off, and one or more additional neural network layers comprising the expander may be appended to the modified trained original neural network. The output vectors from the modified trained original neural network may then be referred to as intermediate classifier vectors. The intermediate classifier vectors may be input to the expander layers, which may be trained using, for example, a loss function that encourages greater sphericity (i.e., penalizes deviations from spherical shape(s)).

In one or more embodiments, the input vectors comprising representations of noisy biometric data derived from sensor readings are input to the modified trained original neural network (e.g., deep neural network) to produce intermediate classifier vectors. The intermediate classifier vectors are input to the expander to produce output vectors from the artificial intelligence classifier that have greater sphericity than the intermediate classifier vectors. In one or more embodiments, the output vectors from the expander will have greater dimensionality in the M-dimensional space than the intermediate classifier vectors in the N-dimensional space, which may permit the artificial intelligence classifier to improve the sphericity of output without sacrificing accuracy.

As noted above, the intermediate classifier vectors corresponding to any one of the enrolled users may cluster together in sets in the N-dimensional vector space (see graphical representations of exemplary sets below the juncture between the artificial neural network and expander of FIG. 4). The degree of sphericity of each set may be determined using any suitable measure. In a simple example, a degree of sphericity within a binary space may be determined based on the Hamming distance from a center fixed point. One of ordinary skill will appreciate that the particular measure for determining degree of sphericity may vary without departing from the spirit of the present invention. Likewise, the degree of sphericity of each cluster or group of output vectors in the M-dimensional space (see graphical representations of exemplary clusters below the juncture between the expander and secure sketch of FIG. 4) may be determined by any suitable measure, provided the measure is comparable or commensurate with the measure selected for use in the N-dimensional space.

In one or more embodiments, the comparison to ensure improved sphericity as between the M- and N-dimensional spaces may respectively include determining averages for the respective sphericity measure across the multiple clusters/groups and sets and comparing the averages to ensure that the output vectors from the expander cluster together with greater sphericity. One of ordinary skill will appreciate that other comparisons may be employed to optimize output from the artificial intelligence classifier for use with the secure sketch steps outlined below without departing from the spirit of the present invention.

As noted above, one of ordinary skill will appreciate that the expander may be appended to other types of classifiers (e.g., a SVM or a K-nearest-neighbors algorithm) to form the artificial intelligence classifier, and that the expander may be omitted wherever the underlying classifier inherently produces output vectors of sufficient sphericity, without departing from the spirit of the present invention.

Moreover, it should be noted that accurate and sufficiently spherical output vectors from the artificial intelligence classifier may be achieved according to training regimens different than that outlined above. For example, in one or more embodiments, the underlying classifier (e.g., artificial neural network or deep neural network) may be appended to the expander before final training, and the combination may be subjected to supervised training (i.e., using labeled training data) for optimizing accuracy and sphericity concurrently. Moreover, various datasets may be used to conduct the training of the underlying or original classifier and/or the expander without departing from the spirit of the present invention.

Referring to step 602 of FIG. 6A, the vector space corresponding to the output vectors may be partitioned into a plurality of regions, with each of the plurality of regions including a pre-defined partitioned fixed point. In one or more embodiments, Voronoi diagrams may be utilized to partition the M-dimensional vector space into the plurality of regions based on the clustered plurality of output vectors. The partitioning may be done with the objective of accurately associating the output vectors corresponding to each of the enrolled users with only one of the pre-defined partitioned fixed points in the vector space, while also reducing the likelihood that any pre-defined point or region will be errantly associated with more than one enrolled user. One of ordinary skill will appreciate that other methods for partitioning may be adopted without departing from the spirit of the present invention.

The pre-defined points corresponding to the plurality of regions of partitioned space may be referred to as a secure sketch comprising codewords of a codebook. In one or more embodiments, the secure sketch may be constructed using any error-correction code, whether defined on discrete or continuous vector spaces, including but not limited to error correction codes for binary symmetric channels, or error correction codes for the Gaussian channel. For example, low-density lattice codes may work well for white Gaussian noise channels or binary symmetric channels. For other examples, low-density parity-check (LDPC) codes, polar codes, turbo codes or the like may be used, preferably in correlation with their respective abilities to approach the capacity of a binary symmetric channel. One of ordinary skill will appreciate that different nomenclature and different methodologies for constructing and maintaining the pre-defined partitioned fixed points in the vector space may be implemented without departing from the spirit of the present invention.

Referring to step 603 of FIG. 6A, a difference vector may be calculated for each of the plurality of enrolled users based on the output vectors and the pre-defined partitioned fixed points. In one or more embodiments, a representative location (another type of fixed point within the vector space) is selected for the output vector(s) of each of the enrolled users within the vector space. For example, each cluster formed by the output vector(s) of one of the enrolled users has a centroid which may, for example, be the Voronoi centroid. The representative location (e.g., the centroid) of each cluster may be decoded to one of the pre-defined partitioned fixed points or codewords of the codebook. For example, the identified codeword may be the closest in the vector space to the representative location or centroid of the corresponding cluster. For another example, the identified codeword may be randomly selected from among those available.

The difference vector for the output vector(s) of each enrolled user may be calculated between the corresponding representative location (e.g., centroid) and the identified codeword or pre-defined partitioned fixed point.

One of ordinary skill will appreciate that a variety of methodologies for relating pre-defined partitioned fixed points to representative locations of output vector(s) corresponding to each of the enrolled users may be implemented without departing from the spirit of the present invention.

Referring to step 604 of FIG. 6A, for each enrolled user, the corresponding difference vector may be stored in computer memory along with an original or cryptographically converted version of at least one vector from which the difference vector was calculated. For example, the representative location (e.g., centroid) associated with the output vector(s) of the enrolled user and/or the identified codeword associated with the enrolled user in the secure sketch may be stored in original or cryptographically converted forms.

It should be noted that referring to the representative location and/or the codeword (i.e., partitioned fixed point) as “fixed point(s)” herein should not be taken to convey absolute permanence. These points are “fixed” between training cycles of the artificial intelligence model and used for authentication events. However, training or updating the artificial intelligence model—for example, based on new biometric data and/or incorporating new enrolled users—may result in new or modified locations for these reference points within the vector space, and corresponding changes to enrollment records, without departing from the spirit of the present invention.

In one or more embodiments, the one or more vectors or fixed points stored with the difference vector is/are cryptographically converted for storage. For example, the one or more vectors or fixed points stored with the difference vector may be hashed by a hashing algorithm prior to storage (e.g., by MD5, SHA-1, SHA-2, NTLM, or LANMAN algorithms) for enhanced protection against hacking. Also or alternatively, the one or more vectors or fixed points stored with the difference vector is/are encrypted prior to storage. Whether hashed/encrypted or not, the one or more vectors or fixed points stored with the difference vector—and which are involved in decoding an output vector within the M-dimensional vector space during authentication—may be referred to herein as the “authentication string.”

Further, codebook parameters, decoding algorithm(s) or other information necessary to evaluate the secure sketch constructed during enrollment are also stored for access during authentication processes (described below), whether with the record of each enrolled user or more generally. Still further, where hashing algorithms are used in storage of the vectors representing the fixed points associated with each enrolled user (i.e., representative locations or partitioned fixed points), information necessary for conducting subsequent hashing operations with the chosen algorithm during authentication (again, as discussed in more detail below) may also be stored (e.g., any non-secret randomness such as salt and pepper used during the hashing process). Also or alternatively, where two-way encryption is used in storage of the vectors representing the fixed points associated with each enrolled user (i.e., representative locations or partitioned fixed points), information necessary for subsequent decryption operations during authentication (again, as discussed in more detail below) may also be stored (e.g., a decryption key). Yet still further, a user identifier—such as a unique alphanumeric string—may be stored with each user enrollment record, received from putative users during authentication events, and used to retrieve the user enrollment record during authentication events.

One of ordinary skill will appreciate that the population of data elements in each enrolled user's enrollment record may vary without departing from the spirit of the present invention. For example, non-secret randomness information may be omitted wherever the authentication device does not implement corresponding hashing protocols. However, it should be noted that it is preferable to store cryptographically converted (e.g., hashed) authentication strings for enhanced security.

Moreover, in one or more embodiments, the database records for each enrolled user may be encrypted prior to storage, and decrypted during each authentication event for use. Further, any external transmissions including biometric data may be encrypted prior to transmission and decrypted for use and analysis.

It should be noted that, even if an attacker hacks the authentication device NVM to obtain an unencrypted difference vector, a corresponding hashed “fixed point” in the record may not be converted to useful information about the vector space for decoding the difference vector. This deprives the attacker of a meaningful method for modeling or otherwise using learned structure to produce synthetic inputs for passing the authentication test.

The above-referenced enrollment steps may be repeated for each of the enrolled users to be enrolled by the authentication device.

Authentication

The steps set out herein generally correspond to the flowchart illustrated in FIG. 6B.

In connection with an authentication event, and referring to step 605 of FIG. 6B, the sensor device may transmit biometric sensor data from a sensor reading of a biometric factor of a putative user to the authentication device. In one or more embodiments, the sensor device may be integrated with the authentication device, negating the need for transmission over a communication network. The putative user may also provide a user identifier for use in matching against an enrollment record.

In one or more embodiments—such as where the sensor device records data regarding surrounding objects—the sensor device may be prompted to record and/or transmit the biometric sensor data by the authentication device based on proximity of the putative user. In another embodiment, the putative user will manually initiate the authentication process by, for example, attempting to access a software application that requires authentication for use. One of ordinary skill will appreciate that a wide variety of events could trigger an authentication event or cycle within the scope of the present invention.

Referring to step 606 of FIG. 6B, the biometric sensor data may be input to the artificial intelligence classifier to generate an authentication output vector. In one or more embodiments, all or some of the biometric sensor data are input as an input vector to the artificial intelligence classifier.

Referring to step 607 of FIG. 6B, an authentication string and difference vector may be retrieved from an enrollment record of an enrolled user. In one or more embodiments, the user identifier may be used to locate the enrollment record. One of ordinary skill will also appreciate that other means of indexing and/or retrieving the corresponding enrollment record may be used without departing from the spirit of the present invention. Where the authentication string comprises an encrypted version of either the representative location of the enrolled user's enrollment output vector(s) or the partitioned fixed point associated with the enrolled user during the enrollment processes outlined above, the authentication string may be decrypted (e.g., by accessing the associated decryption key from memory) in preparation for the matching operations described in more detail below.

Referring to step 608 of FIG. 6B, a pre-defined fixed point may be identified at least in part by subtracting the retrieved difference vector from the output vector.

In one or more embodiments, the authentication string comprises an original or hashed version of the vector of the representative location of the output vector(s) of the enrolled user used during the enrollment processes outlined above in connection with FIG. 6A. Correspondingly, the fixed point identified in step 608 may be the centroid of the cluster of output vectors (or “decision region”) used during training and enrollment to classify the enrolled user. The representative location may be identified during the authentication event represented in FIG. 6B by decoding the authentication output vector within the secure sketch. For example, the difference vector may be subtracted from the authentication output vector within the secure sketch to produce a resultant vector that may be used to identify the corresponding codeword or partitioned fixed point of the codebook. Next, the difference vector may be added to the codeword or partitioned fixed point to return the representative location (i.e., the centroid of the decision region for the enrolled user). Where the authentication string is hashed, the representative location may be hashed for comparison and matching described in more detail below.

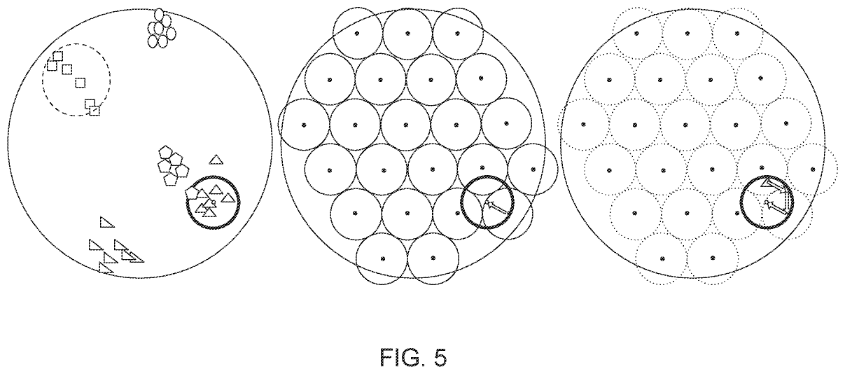

The process for identifying the representative location described in the preceding paragraph is illustrated below the juncture between the Secure Sketch and Hash Function components of FIG. 4, as well as in the rightmost drawing of FIG. 5. The triangle represents the authentication output vector within the vector space, the arrow originating in the triangle represents subtracting the difference vector to generate the resultant vector and decode the output vector to the corresponding codeword, and the arrow originating with the codeword represents addition of the difference vector to the codeword to return the representative location originally determined in connection with enrollment.

In one or more embodiments, the authentication string retrieved from the enrollment record instead comprises an original or hashed version of the vector for the codeword or partitioned fixed point associated with the enrolled user during the enrollment processes outlined above in connection with FIG. 6A. Correspondingly, the fixed point identified in step 608 may be the vector for that codeword or partitioned fixed point. The vector for the codeword or fixed point may be identified during the authentication event represented in FIG. 6B by decoding and subtracting the difference vector from the authentication output vector within the secure sketch. Where the authentication string is hashed, the codeword or partitioned fixed point may be hashed for comparison and matching described in more detail below.

Referring to step 609 of FIG. 6B, the authentication string may be matched to the fixed point to authenticate the putative user as the enrolled user. As noted above, the fixed point may be the vector for the representative location or for the partitioned fixed point within the vector space. Moreover, the fixed point vector may be hashed for comparison if the retrieved authentication string is hashed.

If no match is found, for example to a threshold certainty, the authentication event may be terminated. On the other hand, successful authentication may lead directly to a permitted act authorized by the authentication device. For instance, the authentication device may, based upon completed authentication, signal proper authentication to an actuator that unlocks a door, provide access to a database to the sensor device, transmit a request received from the sensor device to another computing device as an authenticated message, or otherwise act in favor of the putative user as a result of the proper authentication. One of ordinary skill will appreciate that such a permitted act may be a single action (such as unlocking a door), may comprise permitting access for a limited period of time (such as where access to a database is provided for a limited period of time) or may be otherwise configured within the scope of the present invention.

The above-referenced authentication steps may be repeated for each of the putative users to be authenticated by the authentication device.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A computer-implemented method for secure biometric authentication comprising, via one or more processors:
receiving authentication biometric sensor data from an authentication sensor reading of a biometric factor of a putative user;
inputting the authentication biometric sensor data to an artificial intelligence classifier to generate an authentication output vector;
retrieving an authentication string and a difference vector, each of the authentication string and the difference vector being associated with an enrolled user in one or more databases;
identifying a pre-defined fixed point in a vector space at least in part by subtracting the difference vector from the output vector; and
matching the authentication string to the identified fixed point to authenticate that the putative user matches the enrolled user.

2. The computer-implemented method of claim 1, wherein the identified fixed point is defined in the vector space based on one or more enrollment output vectors, each of the one or more enrollment output vectors being generated by inputting enrollment biometric sensor data from an enrollment sensor reading of the biometric factor of the enrolled user to the artificial intelligence classifier.

3. The computer-implemented method of claim 2, wherein—
the one or more enrollment output vectors comprise a plurality, the plurality of enrollment output vectors defining a decision region in the vector space corresponding to the enrolled user,
the identified fixed point corresponds to a representative location comprising the center of the decision region of the enrolled user.

4. The computer-implemented method of claim 3, wherein—
the vector space is mapped to a secure sketch defined by a codebook,
the codebook includes a plurality of codewords comprising partitioned fixed points within the vector space,
the authentication string corresponds to the center of the decision region of the enrolled user,
subtracting the difference vector from the output vector generates a resultant vector,
identifying the identified fixed point in the secure sketch further includes—
decoding the resultant vector within the vector space to locate a corresponding one of the fixed-location codewords,
adding the difference vector to the corresponding one of the fixed-location codewords to identify the identified fixed point corresponding to the center of the decision region of the enrolled user.

5. The computer-implemented method of claim 2, wherein—
the vector space is mapped to a secure sketch defined by a codebook,
the codebook includes a plurality of codewords having fixed locations within the vector space,
the authentication string corresponds to one of the plurality of fixed-location codewords,
subtracting the difference vector from the output vector generates a resultant vector,
identifying the identified fixed point in the secure sketch further includes decoding the resultant vector within the vector space to locate the corresponding one of the fixed-location codewords.

6. The computer-implemented method of claim 1, further comprising, via the one or more processors—
hashing the identified fixed point using a hashing algorithm to generate a hashed fixed point,
wherein the authentication string is hashed by the hashing algorithm and stored in the record and retrieved from the record in a hashed format, and the authentication string in hashed format is matched to the hashed fixed point.

7. The computer-implemented method of claim 1, wherein the artificial intelligence classifier comprises an artificial neural network.

8. The computer-implemented method of claim 1, wherein the authentication string and the difference vector are retrieved using a unique identifier provided by the putative user.

9. A computer-implemented method for building an artificial intelligence model to perform secure biometric authentication comprising, via one or more processors:
inputting representations of noisy biometric data into an artificial intelligence classifier to generate output vectors in a vector space, the noisy biometric data being derived from sensor readings of a biometric factor for a plurality of enrolled users;
partitioning the vector space into a plurality of regions, each of the plurality of regions including a pre-defined partitioned fixed point associated with one of the plurality of enrolled users;
calculating a difference vector for each of the plurality of enrolled users based on a difference between: (i) a representative location of those of the output vectors that correspond to the enrolled user, and (ii) the pre-defined partitioned fixed point corresponding to the enrolled user; and
generating and storing in one or more databases a record for each of the plurality of enrolled users that includes the corresponding difference vector and one or both of the corresponding representative location and the corresponding pre-defined partitioned fixed point.

10. The computer-implemented method of claim 9, wherein—
the artificial intelligence classifier includes an expander comprising a plurality of artificial neural network layers receiving a plurality of intermediate classifier vectors representative of the noisy biometric data as input to generate the corresponding output vectors, the output vectors being grouped in a plurality of clusters and each of the plurality of users corresponding to one of the plurality of clusters,
the plurality of intermediate classifier vectors are grouped into sets, each of the plurality of enrolled users corresponding to one of the sets,
each of the intermediate classifier vectors has N-dimensionality,
each of the output vectors has M-dimensionality,
each of the sets may be embedded in an N-dimensional vector space and may be described in the N-dimensional vector space with a sphere-like score reflecting how closely the set resembles a ball in the N-dimensional vector space,
the output vectors may be embedded in the M-dimensional vector space in groups respectively belonging to one of the plurality of enrolled users,
each of the groups may be described in the M-dimensional vector space with a sphere-like score reflecting how closely the group resembles a ball in the M-dimensional vector space,
the average sphere-like score for the groups in the M-dimensional vector space shows greater sphericity than the average sphere-like score for the sets in the N-dimensional vector space.

11. The computer-implemented method of claim 10, wherein the artificial intelligence classifier further includes a deep neural network configured to receive the noisy biometric data as input to generate the plurality of intermediate classifier vectors.

12. The computer-implemented method of claim 11, further comprising training, via the one or more processors, the artificial intelligence model to generate the output vectors in the plurality of clusters in the vector space at least in part by—
iteratively inputting labeled noisy biometric data to an original deep neural network to configure it for accurate classification of the plurality of enrolled users according to decision regions defined by output of the original deep neural network embedded in an initial vector space of lower dimensionality than the vector space,
peeling off one or more of the final layers of the original deep neural network to form the deep neural network,
feeding the intermediate classifier output vectors generated by the last layer of the deep neural network to the expander to generate the output vectors in the vector space.

13. The computer-implemented method of claim 12, further comprising training, via the one or more processors, the expander to form each of the plurality of clusters to be sphere-like by penalizing deviations from spherical shape(s).

14. The computer-implemented method of claim 10, wherein the artificial intelligence classifier includes a support vector machine configured to receive the noisy biometric data as input to generate the plurality of intermediate classifier vectors.

15. The computer-implemented method of claim 10, wherein the artificial intelligence classifier includes a K-nearest-neighbors algorithm configured to receive the noisy biometric data as input to generate the plurality of intermediate classifier vectors.

16. The computer-implemented method of claim 9, wherein the artificial intelligence model includes a secure sketch comprising a codebook of codewords corresponding to the pre-defined partitioned fixed points within the vector space.

17. The computer-implemented method of claim 16, wherein the secure sketch is constructed using a low-density lattice code based on either white Gaussian noise channels or binary symmetric channels.

18. The computer-implemented method of claim 9, wherein the biometric factor for the plurality of users includes one or more of the following: fingerprint patterns; deoxyribonucleic acid patterns; ocular iris patterns; ocular retina patterns; facial structure or geometric patterns; finger or hand geometric patterns; voice print patterns; typing patterns; ear structure or geometric patterns; gait patterns; infrared body heat patterns; vein or cardiovascular patterns; odor recognition; speech patterns; and written signature patterns.
